(19) United States
(12) Patent Application Publication
(10) Pub. No.: US 2018/0121811 A1
(43) Pub. Date: May 3, 2018

(54) PROFILING A POPULATION OF EXAMPLES IN A PRECISELY DESCRIPTIVE OR TENDENCY-BASED MANNER

(71) Applicant: PTC Inc., Needham, MA (US)

(72) Inventors: Ryan T. Caplan, Huntingdon Valley, PA (US); Bruce F. Katz, Philadelphia, PA (US); Joseph John Pizonka, Pottstown, PA (US)

(21) Appl. No.: 15/563,305

(22) PCT Filed: Apr. 4, 2016
(86) PCT No.: PCT/US16/25874

§ 371 Date: Sep. 29, 2017

Related U.S. Application Data
(60) Provisional application No. 62/142,756, filed on Apr. 3, 2015.
(60) Provisional application No. 62/142,757, filed on Apr. 3, 2015.

(51) Int. Cl. G06N 5/02; G06Q 30/02; G06N 5/00; G06F 15/18; G06F 7/02

(52) U.S. Cl. CPC G06N 5/025; G06Q 30/0201; G06F 7/02; G06F 15/18; G06N 5/003

(57) ABSTRACT

A computer-implemented method for profiling a population of examples includes a computer system creating a rule collection comprising a plurality of rules, wherein each rule describes a respective corresponding sub-population of the examples according to a conjunction of a plurality of feature-value pairs. The computer system generates a precisely descriptive profile by performing a search process on the rule collection to identify a rule that either maximizes or minimizes the value of a user-specified target feature in the respective corresponding sub-population.

### CROSS REFERENCE TO RELATED APPLICATIONS

This application claims the benefit of U.S. Provisional Application Ser. No. 62/142,756, filed Apr. 3, 2015, and U.S. Provisional Application Ser. No. 62/142,757, filed Apr. 3, 2015, each of which is incorporated herein by reference in its entirety.

### TECHNICAL FIELD

The present invention relates generally to methods, systems, and apparatuses for profiling a population of examples in a precisely descriptive or tendency-based manner using machine learning techniques. The disclosed methods, systems, and apparatuses may be applied, for example, to describe datasets corresponding to the population in a compact form for human consumption.

### BACKGROUND

Machine learning is a type of artificial intelligence (AI) that seeks to learn the characteristics and structures of a model representative of dataset. Once a model has been learned, it may be used to better understand the underlying data and to make decisions on how to interpret and process new data. For example, a machine learning model can be used to predict the value of a target variable based on several input variables.

In conventional machine learning models, the degree of transparency present in the model is often inversely proportional to the usefulness of the model. Thus, there is a tradeoff between description and prediction—the harder the model is to understand from the user's perspective, the better it is at making predictions. With conventional machine learning models, it can be difficult to understand why a model is making certain predictions without sacrificing the complexity, sophistication, and accuracy of the model. Accordingly, there is a need for producing machine learning models in a compact form suitable for human consumption, without undue sacrifice in predictive power.

Conventional machine learning models are also not well suited for understanding extreme cases present in a dataset. For example, in the context of a model representative of spending at a particular store, the store owner may desire to know what type of customer spends a large amount of money on purchases (e.g., the top 5% of all spenders based on amount spent). Additionally, the store owner may desire to know what type of customer browses for a long time but doesn't purchase anything. With this information, the store owner can optimize the allocation of marketing and customer service resources based on customer type. Thus, there is also a need for machine learning models to be adapted to better describe extreme cases present in a given population.

### SUMMARY

Embodiments of the present invention address and overcome one or more of the above shortcomings and drawbacks, by providing methods, systems, and apparatuses related to profiling a population of examples in a precisely descriptive or tendency-based manner. Each example is a collection of features and values and may include, without limitation, a person (e.g., a customer, a patient, etc.), a record, and/or a device. Two types of profiles are described herein: precisely descriptive profiles and tendency-based profiles. The former comprise a set of model-driven rules that precisely describe the upper or lower cohorts in the data with respect to a target or goal feature, while the latter comprise a set of statistical tendencies of similar highly-performing or poorly performing cohorts.

Precisely descriptive profiles provide a set of conjunctive conditions maximizing (or minimizing) a goal. Briefly, a precisely descriptive profile may be formed by first adding conditions (feature-value pairs) successively to each rule in a collection of such. Next, the collection is iteratively filtered for maximal utility, where utility is measured either by statistical significance or by goal value given a minimum population constraint. The iterative filtering is performed until no improvement can be found or a predetermined maximal number of conditions have been exceeded. Then, the best such rule that meets all the relevant constraints is returned. This process may then be repeated on the remaining population of examples that do not meet the set of conjunctive conditions in this rule.

According to some embodiments, a computer-implemented method for profiling a population of examples includes a computer system creating a rule collection comprising a plurality of rules, wherein each rule describes a respective corresponding sub-population of the examples according to a conjunction of a plurality of feature-value pairs. The number of feature-value pairs in the rules may be bounded, for example, by a user-specified parameter. The computer system generates a precisely descriptive profile by performing a search process (e.g., beam search, Monte Carlo search, etc.) on the rule collection to identify a rule that either maximizes or minimizes the value of a user-specified target feature in the respective corresponding sub-population. In some embodiments of the aforementioned method, the method further includes an iterative process which comprises removing a particular sub-population covered by the precisely descriptive profile from an example collection and repeating the search process on remaining examples in the example collection to generate a second precisely descriptive profile.

In some embodiments of the aforementioned method, the search process maximizes a utility measurement for each rule in the plurality of rules. For example, in one embodiment, the utility measurement is based on a deviation (above or below) of the user-specified target feature in the respective sub-population from the mean value of the user-specified target feature in the population of examples. This utility measurement may be further based on a weighted function of a value corresponding to the user-specified target feature and a sub-population count proscribed by the rule. In other embodiments, the utility measurement is the magnitude of the Z-score of the respective corresponding sub-population, implicitly defining a weighting between the population count and a target feature deviation from the mean. In still other embodiments, the utility measurement includes a constraint selected from (i) a first constraint that the respective sub-population must include a minimum number of population members or (ii) a second constraint that the respective sub-population must comprise a minimum percentage of the population.

Prior to creating the rule collection in the aforementioned method, a pre-processing process is performed on the population of examples. This pre-processing process includes identifying ordinal features included in the population of examples which correspond to the user-specified target feature and dividing the ordinal features into bins according to corresponding feature values. Next, a condition creation process is performed for each rule. This condition creation process includes identifying a subset of the bins having a significant deviation from the mean value of the population with respect to the user-specified target feature, and combining ordinal features included in the subset of the bins. In some embodiments, the pre-processing process further includes identifying nominal features included in the population of examples. Then, during the condition creation process for each rule, the nominal features are combined into disjunctive subsets of the population of examples.

According to other embodiments, an article of manufacture for profiling a population of examples comprises a non-transitory computer-readable medium holding computer-executable instructions for performing the aforementioned method, with or without the additional features set out above.

According to other embodiments, a system for profiling a population of examples comprises a database and a plurality of processors. The database is configured to store a rule collection comprising a plurality of rules, wherein each rule describes a sub-population of the examples according to a conjunction of a plurality of feature-value pairs. The processors are configured to generate a precisely descriptive profile by performing a search process on the rule collection to identify a rule that either maximizes or minimizes the value of a user-specified target feature in the respective corresponding sub-population.

Tendency-based profiles (or “tendencies,” for short) describe the upper (or lower) slice of the population produced with respect to the goal with a set of independent non-conjunctive characteristic features. Tendencies may be formed by skimming off the highest or lowest performing examples in a dataset, optionally clustering these examples, and then describing this sub-population. For example, a tendency-based rule may be created by first taking the top or bottom subset of a population with respect to the given goal and next clustering into one or more mutually exclusive sets, by population. Then, indicators may be generated describing how these clusters differ from the mean of the population or from each other by means of characteristic conditions (i.e., conditions that maximally deviate in value from the target population).

According to some embodiments, a computer-implemented method for profiling a population of examples in a tendency-based manner includes a computer system receiving a user-specified target feature and determining a performance measurement for each example in the population with regards to the user-specified target feature. The computer system identifies a sub-population of the examples based on the performance measurement determined for each respective example, wherein the sub-population comprises one of (i) highest performers with respect to the user-specified target feature or (ii) lowest performers with respect to the user-specified target feature. Next, the computer system determines a population mean value for the user-specified target feature across the population and identifies feature-value pairs from the sub-population that deviate from the population mean value by more than a predetermined threshold value. Then, the identified feature-value pairs may be displayed for the user. In some embodiments, the method further comprises identifying cohorts in the population related to the user-specified target feature and identifying additional feature-value pairs from the cohorts that deviate from the population mean value by more than the predetermined threshold value. These additional feature-value pairs may also be displayed.

In some embodiments, the aforementioned method for profiling a population of examples in a tendency-based manner further comprises performing similarity-based clustering on the sub-population to generate mutually exclusive sets (e.g., hierarchically on the sub-population). Next, for each respective mutually exclusive set, a first deviation value is determined which is indicative of the degree to which the respective mutually exclusive set deviates from the population mean value with respect to the user-specified target feature. The first deviation value associated with each of the mutually exclusive sets may then be displayed. This general process may be repeated and extended. For example, in some embodiments, for each respective mutually exclusive set, a second deviation value is determined which is indicative of the degree to which the respective mutually exclusive set deviates other members of the mutually exclusive sets with respect to the user-specified target feature. The second deviation value associated with each of the mutually exclusive sets may then be displayed. In some embodiments, the similarity-based clustering described above produces a quasi-optimal number of mutually exclusive sets by an iterative process which comprises creating a new set and successively adding clusters to the new set until the new set does not significantly differ from one or more prior sets.

The aforementioned method for profiling a population of examples in a tendency-based manner may be implemented in some embodiments on a parallel processing platform that comprises a plurality of processors. For example, in one embodiment, the similarity-based clustering is performed in parallel. In other embodiments, each of the processors is configured to operate on a subset of the original population in order to identify examples in this subset, meeting performance criteria. In still other embodiments, each of the processors is configured to determine cohort deviation values over successive slices of the population in parallel.

According to other embodiments, the aforementioned methods for profiling a population of examples in a tendency based manner may be performed by an article of manufacture which comprises a non-transitory computer-readable medium holding computer-executable instructions for performing the methods.

According to other embodiments, a system for profiling a population of examples in a tendency based manner includes a network interface, a plurality of processors, and a display. The network interface is configured to receive a user-specified target feature. The processors are configured to determine a performance measurement for each example in the population with regards to the user-specified target feature and identify a sub-population of the examples based on the performance measurement determined for each respective example, wherein the sub-population comprises one of (i) highest performers with respect to the user-specified target feature or (ii) lowest performers with respect to the user-specified target feature. The processors are further configured to determine a population mean value for the user-specified target feature across the population, and identify feature-value pairs from the sub-population that deviate from the population mean value by more than a predetermined threshold value. The display is configured to present the identified feature-value pairs.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 provides an overview of a system for generating profiles for a population of examples, according to some embodiments of the present invention;

FIG. 2 provides a process which uses a beam search algorithm for determining precisely descriptive profiles, according to some embodiments;

FIG. 3 provides an illustration of nominal features, and how they may be analyzed, according to some embodiments;

FIG. 4 provides an illustration of ordinal features, and how they may be analyzed, according to some embodiments;

FIG. 5 provides a process for forming successive mutually-exclusive precisely descriptive profiles, according to some embodiments;

FIG. 6 provides an overview of a system for generating tendency-based profiles for a population of examples, according to some embodiments of the present invention;

FIG. 7 provides an illustration of a process for generating tendencies, according to some embodiments;

FIG. 8 provides an illustration of a process for automatic cluster count determination, that may be employed in some embodiments;

FIG. 9 shows process illustrating how successive profiling may be applied in the generation of tendencies, according to some embodiments; and

FIG. 10 illustrates an exemplary computing environment within which embodiments of the invention may be implemented.

### DETAILED DESCRIPTION

The following disclosure describes the present invention according to several embodiments directed at methods, systems, and apparatuses for identifying characteristic feature-attribute pairs (or “conditions”) in a population dataset to explain differential performance of a group of examples against an output goal. Each example is a collection of features and values and may include, without limitation, a person (e.g., a customer, a patient, etc.), a record, and/or a device. Application of the techniques described herein result in the generation of one or more “profiles,” which summarize the population of examples in a human-readable manner. The profiles described herein are a way of describing data in a compact form for human consumption, and as such, stand in contrast to “black-box” models with possibly greater predictive power but less transparency. The general aim is to understand how a goal is met (in the case of a binary goal) or is maximized (in the case of a continuous goal). For example, one may wish to understand the characteristics of customers likely to churn (a binary goal), or understand the characteristics of customers likely to spend greater than average amounts (a continuous goal). Two types of profiles are described herein: precisely descriptive profiles and tendency-based profiles. As explained in greater detail below, both types of profiles provide useful information that may be applied in a variety of contexts to intelligently analyze a population dataset.

Profiles stand in contrast to traditional predictive analytics modeling in at least two respects. First, profiles do not describe the entire space of possible output responses, only the “hotspots” (upper or lower regions) of this space. Secondly, profiles produce transparent descriptions of these subspaces, unlike black box models such as neural networks or decision trees or ensembles of such trees. Profiles may also provide direct actionable intelligence not easily accessible from less transparent black box models. For example, one can apply the rules identified by the techniques described herein directly to target customers who are likely to churn. Such customers could conceivably receive special discounts, or other encouragements to prevent them from leaving. Profiles may also form the basis for a deeper understanding of not just what is happening, but why it is happening. For example, if it is found that customers with a high probability of churning are older than the population mean, additional knowledge regarding the product can be drawn upon in an attempt to understand why this is occurring.

### Precisely Descriptive Profiles

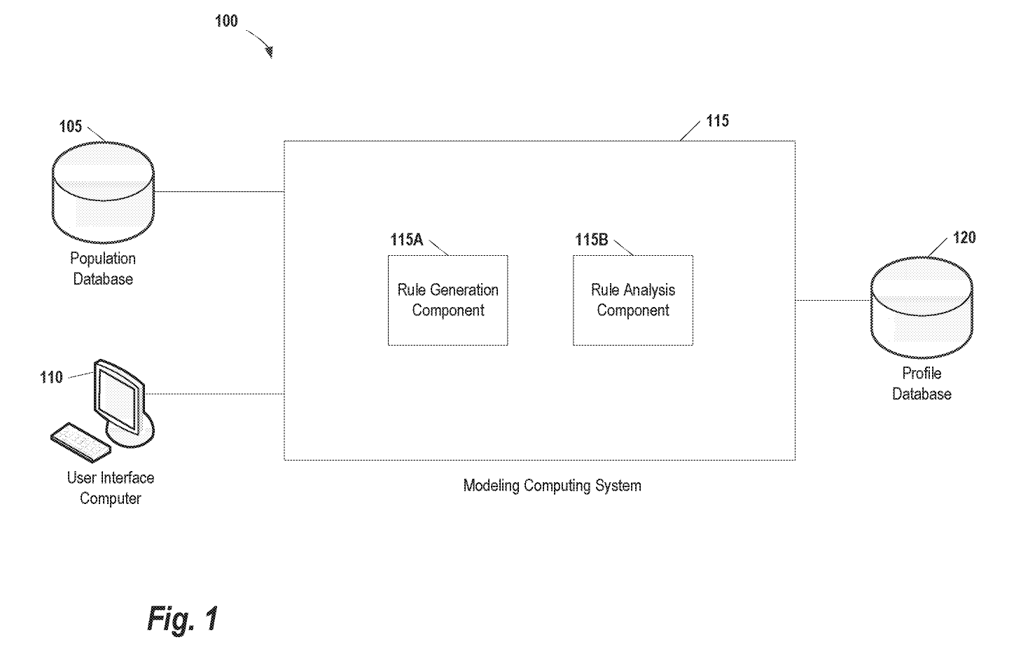

FIG. 1 provides an overview of a system 100 for generating precisely descriptive profiles for a population of examples, according to some embodiments of the present invention. Precisely descriptive profiles may be produced by maximizing significance of particular features or by maximizing the absolute goal value. In the former case, the rule selects for a sub-population that maximizes a significance score (e.g., a Z-score) that implicitly combines both the population size and the deviation from the mean for the population as a whole. In the latter case, the rule describes a sub-population that attempts to maximize the goal, given a minimal population size as a parameter provided to the algorithm. In both cases, conditions may contain nominal or ordinal attributes, the treatment of which varies as described below.

Briefly, the system 100 applies machine learning techniques to generate one or more profiles which define groups of examples within the population. Each profile comprises key defining and differentiating features and attributes of a group of examples. A profile may be defined as a conjunction of a plurality of conditions. Each condition is a feature-attribute pair (e.g., “STATE=NJ”) that a member of the population will either meet or not meet. For example, one profile may be the conjunction of the conditions “State=NJ.” “Age=[50 to 65],” and “Income=low.” The more conditions in a profile, the narrower the population band and the more likely that a higher mean goal value will be found.

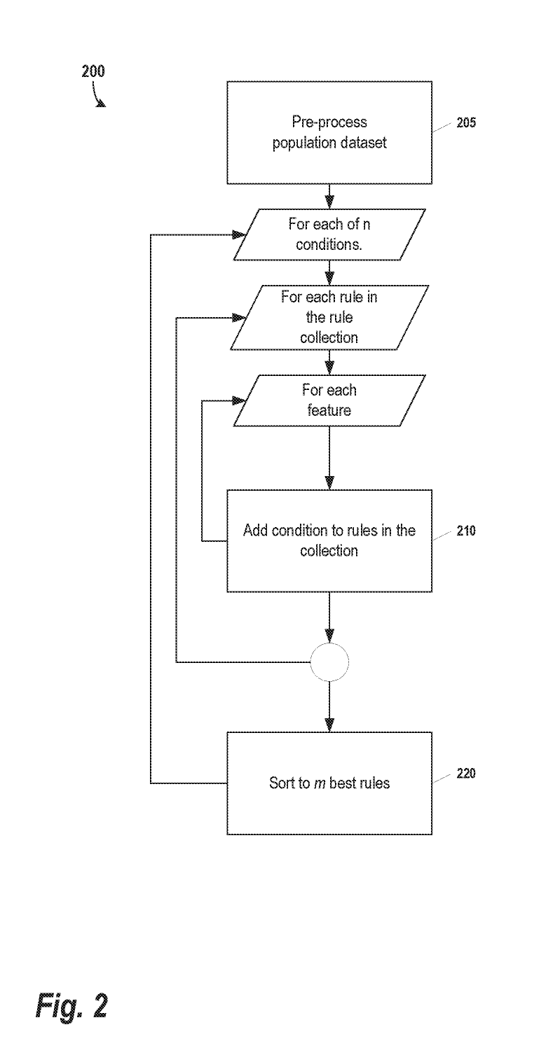

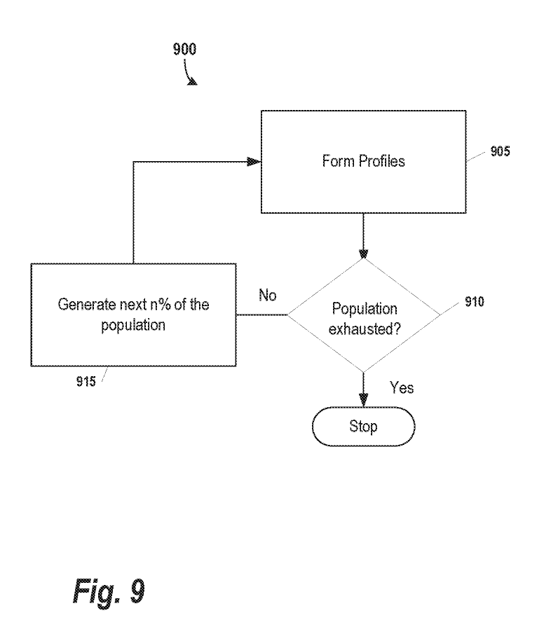

Continuing with reference to FIG. 1, the system 100 includes a Modeling Computing System 115 operably coupled to a Population Database 105 and a User Interface Computer 110. Based on input received from the User Interface Computer 110, the Modeling Computing System 115 retrieves population datasets from the Population Database 105 and processes those datasets using a variety of components (described in further detailed below) to generate one or more profiles which are then stored in a Profile Database 120 or displayed, with or without additional information, on the User Interface Computer 110 (see the description of FIG. 9 below for more information on how data may be presented on the User Interface Computer 110). In some embodiments, the User Interface Computer 110 may be used to specify the type of profile to be generated (e.g., precisely descriptive profiles). In other embodiments, different types of profiles are generated automatically and stored in a Profile Database 120, allowing the user to later retrieve a desired type of profile. Rule Generation Component 115A processes the dataset received from the Population Database 105 and creates a collection of conditions, referred to herein as a “rule” which describes a particular sub-population. Adding conditions to the rule typically has the effect of restricting the sub-population that meets these conditions, but increasing the mean goal value (or decreasing it in the case of minimization). In some embodiments, pre-processing may be performed on the population dataset prior to rule generation to format the data in an optimal manner for rule generation. This pre-processing may be performed by the Rule Generation Component 115A or by a component specifically configured for pre-processing tasks (not shown in FIG. 1). In one embodiment, described in greater detail below with reference to FIG. 2, rules are created by processing each condition (i.e., feature-attribute pair) in the population dataset independently, adding the conditions to existing rules (using a conjunctive operator) or creating new rules, as appropriate.

A Rule Analysis Component 115B processes each condition in the rule to determine analytical information such as, without limitation, the size of the population that the condition is applicable to, the correspondence between the condition and the mean goal value, and the Z-score. In some embodiments, the output of the Rule Analysis Component 115B is one or more precisely descriptive profiles which are then stored in the Profile Database 120 and/or presented to the user at the User Interface Computer 110.

It should be noted that the components 115A and 115B illustrated in FIG. 1 are only a sampling of the different components that may be included in the Modeling Computing System 115. In some embodiments, the functionality corresponding to these components can be merged and/or supplemented with additional functionality. Additionally, in other embodiments, the Modeling Computing System 115 may include additional components that provide additional modeling functionality not described herein.

To illustrate precisely descriptive profiles, consider an analysis which seeks to determine a rule with no more than 3 conditions that maximizes the significance of a sub-population for customer churn, as measured by the Z-score (or some other suitable statistic) derived from a database of customers, their characteristics, and a Boolean flag indicating whether they churned or not, while still capturing at least 1% of the population. These results are shown in the following table:

| | Population | Mean goal value | Z-score |
|---|---|---|---|
| i) State = NJ | 3.4% | .72 | 12.3 |
| ii) Age = [50 to 65] | 2.1% | .89 | 19.2 |
| iii) Income = [20,000-47,000] | 1.9% | .91 | 23.6 |

Here, three conditions have been identified: individuals with a state (e.g., residence) designated as New Jersey; individuals aged between 50 and 65 years old; and individuals with incomes between $20,000 and $47,000. The Z-score is proportional to the number of standard deviations each population subset is above the mean, and the size of that subset. Thus, it can be used as a measure that guides the search process toward sub-populations that combine high goal value with relatively large population counts.

As an alternative to the example presented above, a different utility function may be used in the search process, maximizing the goal value while still meeting a minimum percentage of the population as opposed to maximizing the Z-score. The table provided below illustrates a rule that maximizes churn itself, given that at least 1% of the population must be described by the rule.

| | Population | Mean goal value | Z-score |
|---|---|---|---|
| i) State = PA | 1.8% | .88 | 10.1 |
| ii) Do not call = true | 1.4% | .93 | 14.2 |
| iii) Income = [20,000-47,000] | 1.2% | .95 | 18.7 |

In each of the tables provided above, the statistics to the right of the condition indicate the successive effect of adding that condition to the rule. Note that, as conditions are added, the proscribed population decreases, but the mean goal value increases. Note also that the second mode is likely to produce a rule with a higher mean goal value but with lower significance than the first mode.

In addition to constraining the rule by minimum population, a maximal setting on the number of conditions may also be specified. In general, adding more conditions will increase significance and/or goal value; however, shorter and simpler descriptions may be preferred, consistent with the fact that the overarching aim of these algorithms is to provide comprehensible and possibly actionable descriptions of the population extrema.

FIG. 2 provides a process 200 that uses a beam search algorithm for determining precisely descriptive profiles, according to some embodiments. As is understood in the art, beam search is a heuristic search algorithm that explores a graph by expanding the most promising nodes in a limited set sized according to a predetermined beam width value. The process 200 shows the implementation of profiles with a beam search that limits consideration to the best m cases for each of the n rule conditions, where m and n are predetermined values which may be configured, for example, based on the characteristics of the computing environment or other system limitations. It should be noted that, in addition to the process 200, other search paradigms may be used in different embodiments such as, without limitation, depth-first search, and, for datasets with especially large numbers of features, a Monte Carlo search. Like beam search, pruning of some sort may be employed to prevent combinatorial explosion for datasets of moderate or greater size.

Continuing with reference to FIG. 2, at step 205, the population dataset is pre-processed according to its constituent feature types and values. Pre-processing at step 205 is intended to format the data in a manner that eases execution of the later steps of the process 200. In some embodiments, the dataset may be pre-processed in the following manner. Assume that the original population dataset comprises a collection of rows, with each row an ordered list of values according to feature. For nominal features these values will be strings; for ordinal features these values will be real numbers. In the case of the former, the string is converted to an integer in the range of possible attributes indicating the index of that attribute. In the case of ordinals, the number may be placed into a bin included in a set of bins that divides the range of goal values equally. In addition to formatting the data, the pre-processing performed at step 205 also includes the creation of an empty (or null) rule collection.

Following pre-processing, an empty (or null) rule collection is created. Then, the rule collection is populated and refined at step 210. In the example of FIG. 2, each condition is processed. Each rule comprises one or more conditions. Thus, step 210 may be understood as iteratively adding conditions to a set of rules until a stopping condition is satisfied. In some embodiments, the stopping condition is when the number of maximal conditions have been reached (if provided), or if significance or goal value can no longer be improved. In other embodiments, the algorithm executes until the population dataset is exhausted. For illustration, the rule creation process is illustrated in FIG. 2 as a triple-nested-loop. However, it should be understood that the general algorithm may be adjusted in other embodiments in order to reduce the overall complexity of the process 200. Existing rules, comprising a set of previously generated conditions, may be augmented by a new condition in one of two ways, depending on whether the features are nominal or ordinal.

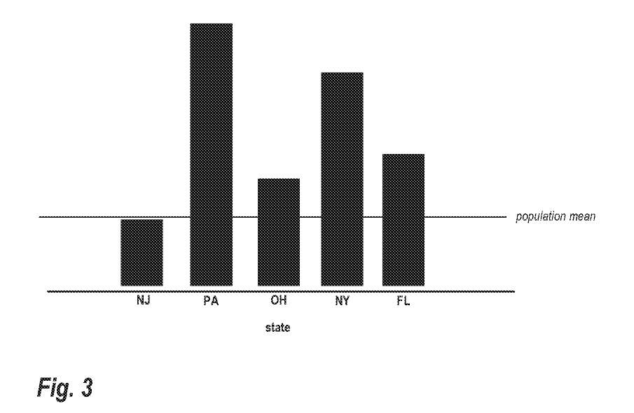

A nominal feature is a feature with an unordered set of attributes, such as state or color. FIG. 3 provides an illustration of nominal features, according to some embodiments. The height of the bars in FIG. 3 shows the relative goal value with STATE as the feature. Note that these are the values after the other conditions, if any, in the existing rule have diminished the population. Thus, all values will be close to or above the mean for the population as a whole. The best n attributes, where n is an algorithm parameter, may be selected to create n new rules with the appended condition. For example, if n were 2, then the conditions STATE=PA and STATE=NY would be added as a new condition to the current rule to create 2 new rules. As indicated in the flow chart shown in FIG. 2, this is done for each of the rules in the current rule set. In some embodiments, when maximizing significance for nominal features, disjunctions may optionally be chosen that meet a minimal significance threshold. For example, in FIG. 3, the new condition STATE=NJ or PA may be generated if the population of each of these attributes is sufficiently large.

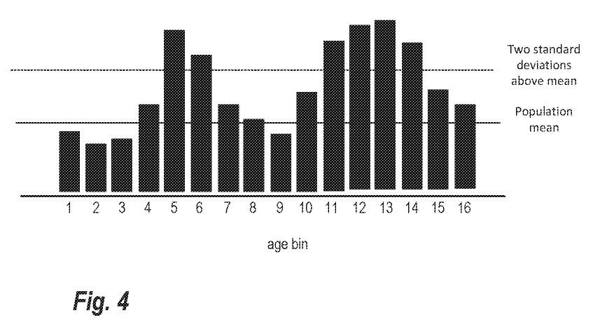

An ordinal feature is a feature with a continuous range of attributes, such as height or income. FIG. 4 provides an illustration of how ordinal features may be analyzed, according to some embodiments. As with nominal features, the height of the bars in FIG. 4 shows the relative goal value. In this example, however, the feature values have been divided into 16 bins of equal size over the considered age span. The aim in this case is to find sets of contiguous bins with relatively high values. This process is guided by a threshold parameter indicating the minimum number of standard deviations above the mean that each bar must meet. This threshold parameter may be set, for example, based on the user input. In FIG. 4, where the threshold parameter is set to two standard deviations, two intervals may be generated: the first comprising bins 5 and 6, and the second 11 through 14. Each of these intervals is added as a condition to the current rule, and a similar process is carried out for each rule in the current rule set. In some embodiments, when maximizing significance for ordinal features, subsets of ranges may optionally be considered that produce greater significance in the current condition, or upon search for future conditions. For example, in FIG. 4, a range consisting solely of bin 5 and bin 6 may be considered, as well as all possible sub-ranges derived from the larger range of bins 11 to 14.

Returning to FIG. 2, once the rules have been determined, at step 220 the rules are sorted to a predetermined number of best rules based on a significance score. This significance score is representative of the deviation of each rule from the mean of the population and may be captured, for example, in a Z-Score value determined for the rules. In some embodiments, the significance score is designed to implicitly combine population count and deviation from the mean using the Z-Score. In other embodiments, the relative weight of the deviation from the mean and the population size may be explicitly specified by the user, in order to bias the search in one direction or the other. Other more complex functions between these two measures are also possible.

Although the process 200 illustrated in FIG. 2 identifies the maximal performers among the population it may also (or alternatively) be of interest to identify the minimal performers. For example, a company may wish to know which of its customers are least likely to churn. Algorithmically, the process of generating these profiles is similar to that discussed above except that at step 220, the greatest utility is assigned to profiles with the lowest mean goal values.

Upon termination of the algorithm (e.g., the maximal number of conditions has been exceeded, or there are no additional conditions that can be added that meet the constraints of the problem), the top rule in the sorted list of rules is returned. This will be, by virtue of the sorting process, the single best profile meeting all of the user-prescribed constraints.

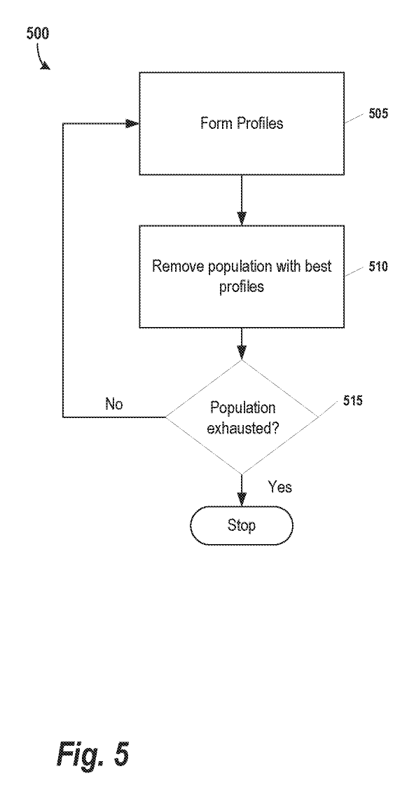

In some cases, it may be desirable to repeat this entire process. FIG. 5 provides a process 500 for forming successive mutually-exclusive precisely descriptive profiles, according to some embodiments. It may be desirable to know not only the best profile for a given goal, but also alternatives that describe successive population sets. For example, one might wish to know profiles that cover not just the top approximate 1% of the population, at a minimum, but also profiles for the next 1%, and so on. Starting at step 505, profiles are formed from a population dataset, for example, using the process illustrated in FIG. 2. Next, at step 510, the best profile is identified and the corresponding population is removed from the population dataset. Then, at step 515, the population is evaluated to determine if it is exhausted. If so, the process stops. However, if the population is not exhausted, the process 500 repeats, starting at 505.

In the case of large datasets, comprising a relatively large number of examples or features within such examples or both, the preceding algorithm may be parallelized to improve the speed of computation or to reduce memory demands. For example, using a Map-Reduce paradigm such as implemented via Apache Hadoop or Apache Spark, the examples can be divided into a set of m mutually-exclusive sets for processing at the point of determining the next condition to add to a set of previously generated rules. The effect on the mean goal value for each of these m sets can then be determined in parallel, and these can then be recombined in the Reduce step to form the statistics for the population as a whole. In this way, multiple machine cores with individual memories can be exploited for the purposes of speed and reduced space. It is also possible to parallelize the algorithm by operation, namely, by dividing up the conditions added at each time step into a set of mutually exclusive sets. These sets would then be distributed among differing machine cores, and combined to choose the best m rules at the end of this process (220 in FIG. 2).

### Tendency-Based Profiles

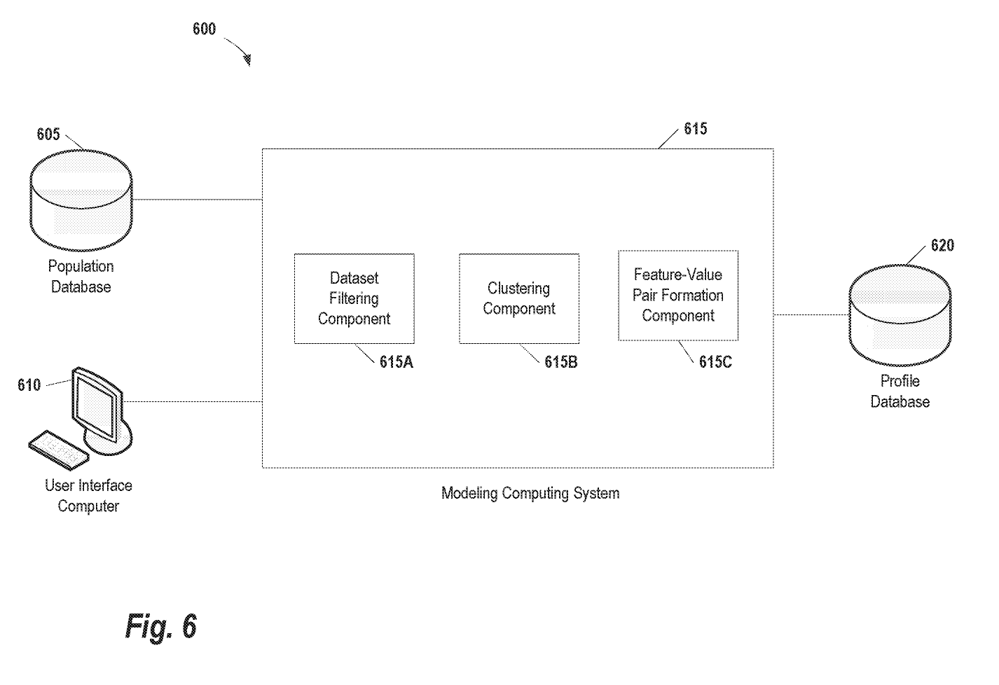

FIG. 6 provides an overview of a system 600 for generating tendency-based profiles for a population of examples, according to some embodiments of the present invention. Whereas precisely-descriptive profiles identify subsets of the population that maximize significance of particular features or an absolute goal value, tendencies are a way of directly answering the question, “What is different about the top-performing cohort of the population from the population as a whole?” As such, they stand in contrast to traditional clustering techniques that are typically applied to the entire dataset, and at best give an indirect answer to this question. With these prior methods, the goal is just one feature among a sea of other competing features, and therefore has little influence on the outcome of clustering. One could attempt to overcome this by weighting the goal feature more highly than that of other features, but there still is no guarantee that the top (or bottom) performing cohorts will appear in the population, and no guarantee that a precise percentage of such could be met or even approximated.

Tendencies may be formed by first skimming off the highest or lowest performing examples in a dataset, clustering these sets of examples, and then attempting to describe this sub-population with a set of characteristic conditions of the centroid (a list of mean values for the members of the cluster, by feature) of the cluster. These conditions are not conjunctive, and are listed in order of precedence (more characteristic to less characteristic). Moreover, as these conditions represent average tendencies, not every example in the derived subset will exhibit deviations as large as the centroid itself.

Similar to the system described above with respect to FIG. 1, the system 600 applies machine learning techniques to generate one or more profiles which define groups of examples within the population. Each profile comprises key defining and differentiating features and attributes of a group of examples. The system 600 further includes a Modeling Computing System 615 operably coupled to a Population Database 605 and a User Interface Computer 610. Based on input received from the User Interface Computer 610, the Modeling Computing System 615 retrieves population datasets from the Population Database 605 and processes those datasets using a variety of components 615A, 615B, 615C to generate one or more tendency-based profiles which are then stored in a Profile Database 620 or displayed, with or without additional information, on the User Interface Computer 610 (see the description of FIG. 9 below for more information on how data may be presented on the User Interface Computer 610). In some embodiments, the User Interface Computer 610 may be used to specify the type of profile to be generated (e.g., tendency-based profiles). In other embodiments, different types of profiles are generated automatically and stored in a Profile Database 620, allowing the user to later retrieve a desired type of profile.

The Modeling Computing System 615 includes a Dataset Filtering Component 615A which generates subsets of the population dataset received from the Population Database 605 based on one or more criteria. In some embodiments, the Dataset Filtering Component 615A is configured to determine the top n % or the bottom n % of the population according to a population constraint. In this context, n is a predetermined number selected, for example, by a user. For example, if the population constraint is “high income earners,” the Dataset Filtering Component 615A could return the top 10% of all members of the population identified as having high income.

Clustering Component 615B forms disjoint clusters based on a population dataset or a filtered subset of that dataset. The Clustering Component 615B may be configured to execute various clustering algorithms including, without limitation, k-means clustering, fuzzy c-means clustering, hierarchical clustering, expectation-maximization clustering, quality threshold clustering, minimum spanning tree based clustering, kernel k-means clustering, and density-based clustering algorithms.

A Feature-Value Pair Formation Component 615C determines pairs of features and values present in clusters generated by Clustering Component 615B. In some embodiments, the Feature-Value Pair Formation Component 615C is also configured to identify feature-value pairs which deviate from the total set of feature-value pairs calculated for a particular cluster. For example, in one embodiment, for each cluster, feature-value pairs are formed that maximally deviate from the original population and/or other clusters. The deviation of each feature-value pair can be determined using any technique known in the art. In some embodiments, the feature-value pairs vary by value relative to the mean of the population (or other clusters). For example, if a cluster has a mean income of $126,000, this could be 2.1 standard deviations above the mean for the population as a whole. In some embodiments, the output of the Feature-Value Pair Formation Component 615C is one or more tendency-based profiles which are then stored in the Profile Database 620 and/or presented to the user at the User Interface Computer 610.

It should be noted that the components 615A, 615B, and 615A, illustrated in FIG. 6 are only a sampling of the different components that may be included in the Modeling Computing System 615. In some embodiments, the functionality corresponding to these components can be merged and/or supplemented with additional functionality. Additionally, in other embodiments, the Modeling Computing System 615 may include additional components that provide additional modeling functionality not described herein.

To illustrate tendency-based profiles, consider data describing hospital stays by a population. The top 5% of hospital stays by cost are segregated from the population as a whole for analysis. These are then divided into 2 clusters. The table below includes two tendency-based profiles illustrating two fundamental tendencies for this cohort: heart attack patients and patients with advanced cancer. Shown for each are the ranked conditions by the standard deviation of prominence of each condition relative to the population as a whole, and the same statistic relative to means for the entire selected cohort (the top 5%). As previously stated, these are merely tendencies; i.e., mean deviations are presented only, and not every cluster member will have a deviation of this magnitude.

| | | |
|---|---|---|
| | Standard | Standard |
| | Deviation from | Deviation from |
| Condition | Population Mean | top 5% |

Tendency 1

| | | |
|---|---|---|
| Primary diagnosis = M. infarction | 3.15 | 1.23 |
| Age = [50 to 65] | 2.78 | 2.37 |
| Diabetes = yes | 1.42 | 0.056 |

Tendency 2

| | | |
|---|---|---|
| Primary diagnosis = Stage 4 cancer | 4.92 | 1.56 |
| Smoking = yes | 2.71 | 2.11 |
| Age = [65 to 75] | 2.22 | 1.31 |

While it is possible to also produce a description of this cohort without clustering, this would not accurately reflect that there are two distinct sub-cohorts within the selected cohort that are leading to high costs; hence the need to further refine the analysis by clustering through similarity. Note also that clustering without first filtering would yield different results that would tend to wash out the trends revealed by the individual clusters. Hence, the two steps of the algorithm, filtering and then clustering, produce a unique description of the outlying cohort, and one that cannot easily be obtained otherwise.

Furthermore, each of cluster descriptions could potentially be an actionable target to reduce costs, and the knowledge gleaned from tendencies can be worked into more general theories describing the goal. In this case, for example, the characteristic features in the clusters could be used to argue that end-stage care is significantly more expensive than earlier-stage care.

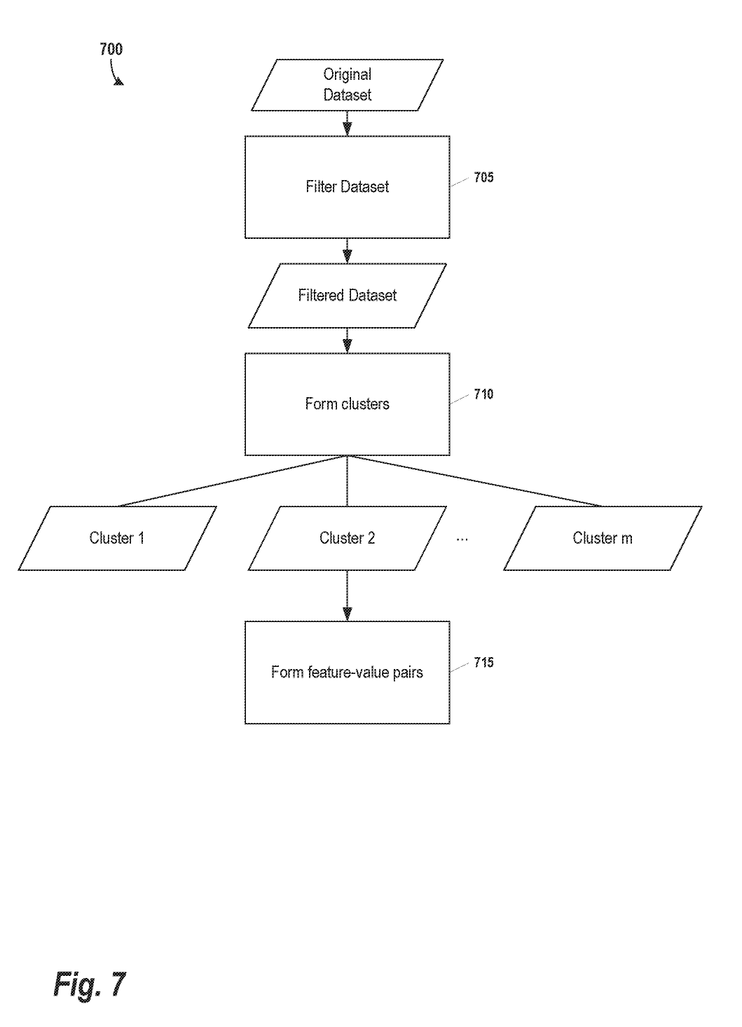

FIG. 7 provides an illustration of a process 700 for generating tendencies, according to some embodiments. Briefly, the process 700 includes forming the cohort, applying a clustering technique such as k-means, and then forming statistics that describe the deviation of each cluster from the population as a whole, and from other members of the derived cohort. Starting at step 705, a dataset is filtered to the top or bottom n %, where n is equal to the size of the desired output (e.g., specified by user input). Next, at step 710, a predetermined number (represented in FIG. 7 as “m”) of disjoint clusters are formed, for example, using k-means processing or other clustering algorithms generally known in the art. Again, the number of clusters formed (i.e., the value of “m”) may be a user-configurable parameter based on the, for example, the desired specificity in the resultant clusters.

In some embodiments, instead of forming m fixed clusters, alternative clustering techniques may be applied at step 710. For example, in some embodiments, profiles are formed hierarchically by first describing the exceptional cohort as a whole, dividing this into 2 (or more) clusters and describing these, and then further dividing these into clusters, etc. In other embodiments, an automatic cluster count determination process may be used where, instead of forming m fixed clusters, the cluster count is determined by first forming 2 clusters, then 3, etc. This process ends when a new cluster is formed with a centroid that does not deviate by a parameter-based threshold from the nearest cluster in the previously generated set. Then, at step 715, feature-value pairs may be formed based on the clusters.

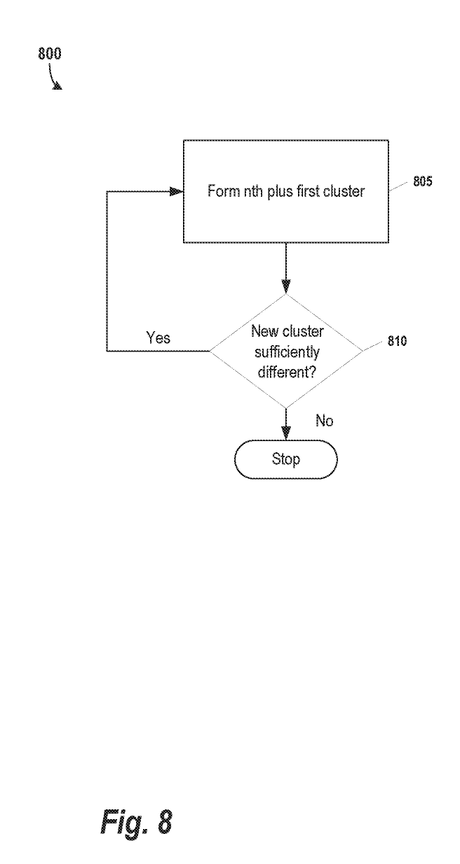

FIG. 8 provides an illustration of a process 800 for automatic cluster count determination that may be employed in some embodiments. At step 805, the nth+first cluster is formed given that n clusters have already been formed. That is, instead of forming m fixed clusters, the cluster count is determined by first forming 2 clusters, then 3, etc. Next, at 810, the centroid of the new cluster is tested to determine whether it deviates by a parameter-based threshold from the nearest cluster in the previously generated set. If the new cluster is sufficiently different, the process 800 is repeated starting at 805. If the new cluster is not sufficiently different, the process ends and the n clusters are returned. Each cluster may then be processed to form (a) feature value pair that maximally deviate from the original population and (b) feature-value pairs that maximally deviate from the other clusters.

FIG. 9 shows process 900 illustrating how successive profiling may be applied in the generation of tendencies, according to some embodiments. Briefly, the profiles are formed for the first n % of the population, the next n %, etc., until the entire population is described. At step 905, profiles are formed on the population subset, for example, using the process described above with respect to FIG. 7. Next, at 910, a check is made to see if the population is exhausted. If it is not, at step 915, the next n % of the population is generated. However, if the population is exhausted, the process 900 ends. The resulting collection of profiles, each of which may be based on multiple clusters, then describe each segment of the population and how it deviates from the typical member of the population. For example, in the prior example, it may be useful to know not only the characteristics of the most extreme cohorts, high and low with respect to cost, but also the band just below and above respectively.

In some embodiments, the aforementioned methods of creating tendency-based profiles may be implemented across multiple processors in a parallel processing computing architecture. The above operations may be parallelized in a variety of ways. For example, the formation of characteristics of a cohort that deviate maximally from the mean may be derived by dividing this sub-population among various processors, and then combining the results. In addition, the entire process of operating on a sub-cohort may be subdivided in a natural fashion; for example, the top 5% could be sent to processor 1, the next 5% to processor 2, etc. Finally, various aspects of the clustering process could be accomplished in parallel. For example, if binary hierarchical clustering is specified, then the two initial clusters formed could be themselves clustered on two separate processors.

Various techniques may be applied for outputting the information relevant to the tendency-based profiles described herein. For example, in some embodiments, profile information may be stored in a database which provides access to various profiles based on, for example, a goal value. In other embodiments, profiles may be generated “on the fly” based on user input for display in a Graphical User Interface (GUI). In some embodiments, this GUI allows the user to interactively select and manipulate various characteristics of the displayed clusters. Thus, for example, a user can drill down on a particular population by dynamically adding or removing features. Additionally, in some embodiments, the GUI may be used to update any offline storage of the population and profile information.

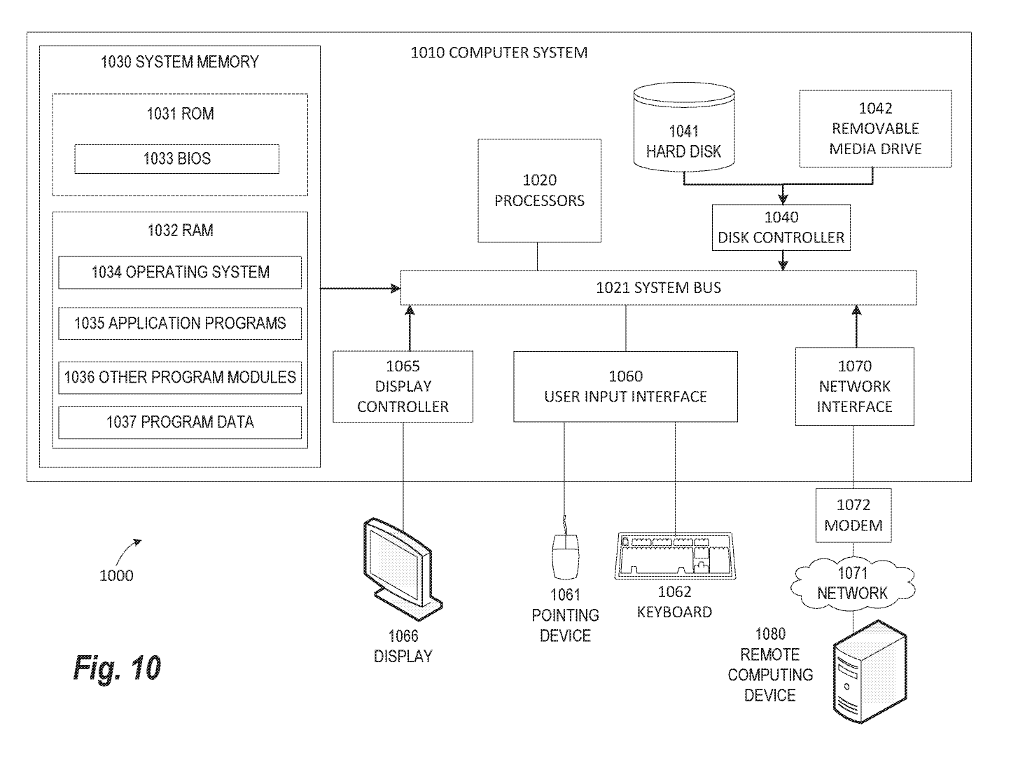

FIG. 10 illustrates an exemplary computing environment 1000 within which embodiments of the invention may be implemented. For example, computing environment 1000 may be used to implement one or more components of system 100 shown in FIG. 1. Computers and computing environments, such as computer system 1010 and computing environment 1000, are known to those of skill in the art and thus are described briefly here.

As shown in FIG. 10, the computer system 1010 may include a communication mechanism such as a system bus 1021 or other communication mechanism for communicating information within the computer system 1010. The computer system 1010 further includes one or more processors 1020 coupled with the system bus 1021 for processing the information.

The processors 1020 may include one or more central processing units (CPUs), graphical processing units (GPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general-purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 10, the computer system 1010 also includes a system memory 1030 coupled to the system bus 1021 for storing information and instructions to be executed by processors 1020. The system memory 1030 may include computer readable storage media in the form of volatile and/or nonvolatile memory, such as read only memory (ROM) 1031 and/or random access memory (RAM) 1032. The RAM 1032 may include other dynamic storage device(s) (e.g., dynamic RAM, static RAM, and synchronous DRAM). The ROM 1031 may include other static storage device(s) (e.g., programmable ROM, erasable PROM, and electrically erasable PROM). In addition, the system memory 1030 may be used for storing temporary variables or other intermediate information during the execution of instructions by the processors 1020. A basic input/output system 1033 (BIOS) containing the basic routines that help to transfer information between elements within computer system 1010, such as during start-up, may be stored in the ROM 1031. RAM 1032 may contain data and/or program modules that are immediately accessible to and/or presently being operated on by the processors 1020. System memory 1030 may additionally include, for example, operating system 1034, application programs 1035, other program modules 1036 and program data 1037.

The computer system 1010 also includes a disk controller 1040 coupled to the system bus 1021 to control one or more storage devices for storing information and instructions, such as a magnetic hard disk 1041 and a removable media drive 1042 (e.g., floppy disk drive, compact disc drive, tape drive, and/or solid state drive). Storage devices may be added to the computer system 1010 using an appropriate device interface (e.g., a small computer system interface (SCSI), integrated device electronics (IDE), Universal Serial Bus (USB), or FireWire).

The computer system 1010 may also include a display controller 1065 coupled to the system bus 1021 to control a display or monitor 1066, such as a cathode ray tube (CRT) or liquid crystal display (LCD), for displaying information to a computer user. The computer system includes an input interface 1060 and one or more input devices, such as a keyboard 1062 and a pointing device 1061, for interacting with a computer user and providing information to the processors 1020. The pointing device 1061, for example, may be a mouse, a light pen, a trackball, or a pointing stick for communicating direction information and command selections to the processors 1020 and for controlling cursor movement on the display 1066. The display 1066 may provide a touch screen interface that allows input to supplement or replace the communication of direction information and command selections by the pointing device 1061.

The computer system 1010 may perform a portion or all of the processing steps of embodiments of the invention in response to the processors 1020 executing one or more sequences of one or more instructions contained in a memory, such as the system memory 1030. Such instructions may be read into the system memory 1030 from another computer readable medium, such as a magnetic hard disk 1041 or a removable media drive 1042. The magnetic hard disk 1041 may contain one or more datastores and data files used by embodiments of the present invention. Datastore contents and data files may be encrypted to improve security. The processors 1020 may also be employed in a multi-processing arrangement to execute the one or more sequences of instructions contained in system memory 1030. In alternative embodiments, hard-wired circuitry may be used in place of or in combination with software instructions. Thus, embodiments are not limited to any specific combination of hardware circuitry and software.

As stated above, the computer system 1010 may include at least one computer readable medium or memory for holding instructions programmed according to embodiments of the invention and for containing data structures, tables, records, or other data described herein. The term “computer readable medium” as used herein refers to any medium that participates in providing instructions to the processors 1020 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 1041 or removable media drive 1042. Non-limiting examples of volatile media include dynamic memory, such as system memory 1030. Non-limiting examples of transmission media include coaxial cables, copper wire, and fiber optics, including the wires that make up the system bus 1021. Transmission media may also take the form of acoustic or light waves, such as those generated during radio wave and infrared data communications.

The computing environment 1000 may further include the computer system 1010 operating in a networked environment using logical connections to one or more remote computers, such as remote computing device 1080. Remote computing device 1080 may be a personal computer (laptop or desktop), a mobile device, a server, a router, a network PC, a peer device or other common network node, and typically includes many or all of the elements described above relative to computer system 1010. When used in a networking environment, computer system 1010 may include modem 1072 for establishing communications over a network 1071, such as the Internet. Modem 1072 may be connected to system bus 1021 via user network interface 1070, or via another appropriate mechanism.

Network 1071 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 1010 and other computers (e.g., remote computing device 1080). The network 1071 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 1071.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine-readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity. Also, while some method steps are described as separate steps for ease of understanding, any such steps should not be construed as necessarily distinct nor order dependent in their performance.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

1. A computer-implemented method for profiling a population of examples, the method comprising:
creating, by a computer system, a rule collection comprising a plurality of rules, wherein each rule describes a respective corresponding sub-population of the examples according to a conjunction of a plurality of feature-value pairs; and
generating, by the computer system, a precisely descriptive profile by performing a search process on the rule collection to identify a rule that either maximizes or minimizes a value of a user-specified target feature in the respective corresponding sub-population.

2. The method of claim 1, wherein the search process is implemented using a beam search algorithm.

3. The method of claim 1, wherein the search process is implemented using a Monte Carlo search algorithm.

4. The method of claim 1, wherein the search process maximizes a utility measurement for each rule in the plurality of rules.

5. The method of claim 4, wherein the utility measurement is based on a deviation (above or below) of the user-specified target feature in the respective corresponding sub-population from the mean value of the user-specified target feature in the population of examples.

6. The method of claim 5, wherein the utility measurement is further based on a weighted function of the value corresponding to the user-specified target feature and a sub-population count proscribed by the rule.

7. The method of claim 4, wherein the utility measurement is the magnitude of the Z-score of the respective corresponding sub-population, implicitly defining a weighting between population count and a target feature deviation from the mean.

8. The method of claim 4, wherein the utility measurement includes a constraint selected from (i) a first constraint that the respective sub-population must include a minimum number of population members or (ii) a second constraint that the respective corresponding sub-population must comprise a minimum percentage of the population.

9. The method of claim 1 wherein the number of feature-value pairs in the plurality of rules is bounded by a user-specified parameter.

10. The method of claim 1, further comprising:
prior to creating the rule collection, performing a pre-processing process on the population examples comprising:
identifying a plurality of ordinal features included in the population of examples which correspond to the user-specified target feature;
dividing the plurality of ordinal features into a plurality of bins according to corresponding feature values; and
performing a condition creation process for each rule comprising:
identifying a subset of the plurality of bins having a significant deviation from the mean value of the population with respect to the user-specified target feature, and
combining ordinal features included in the subset of the plurality of bins.

11. The method of claim 10, wherein the pre-processing process further comprises:
identifying a plurality of nominal features included in the population of examples; and
during the condition creation process for each rule, combining the plurality of nominal features into disjunctive subsets of the population of examples.

12. The method of claim 1, wherein the method further comprises an iterative process comprising:
removing a particular sub-population covered from by the precisely descriptive profile from an example collection; and
repeating the search process on remaining examples in the example collection to generate a second precisely descriptive profile.

13. A system for profiling a population of examples, the system comprising:
a database configured to store a rule collection comprising a plurality of rules, wherein each rule describes a respective corresponding sub-population of the examples according to a conjunction of a plurality of feature-value pairs; and
a plurality of processors configured to generate a precisely descriptive profile by performing a search process on the rule collection to identify a rule that either maximizes or minimizes a value of a user-specified target feature in the respective corresponding sub-population.

14. A computer-implemented method for profiling a population of examples, the method comprising:
receiving, by a computer system, a user-specified target feature;
determining, by the computer system, a performance measurement for each example in the population with regards to the user-specified target feature;
identifying, by the computer system, a sub-population of the examples based on the performance measurement determined for each example, wherein the sub-population comprises one of (i) highest performers with respect to the user-specified target feature or (ii) lowest performers with respect to the user-specified target feature;
determining, by the computer system, a population mean value for the user-specified target feature across the population;
identifying, by the computer system, feature-value pairs from the sub-population that deviate from the population mean value by more than a predetermined threshold value; and
displaying the identified feature-value pairs.

15. The method of claim 14, further comprising:
performing similarity-based clustering on the sub-population to generate a plurality of mutually exclusive sets;
for each mutually exclusive set, determining a first deviation value indicative of a degree to which the mutually exclusive set deviates from the population mean value with respect to the user-specified target feature; and
displaying the first deviation value associated with each of the plurality of mutually exclusive sets.

16. The method of claim 15, further comprising:
for each mutually exclusive set in the plurality of mutually exclusive sets, determining a second deviation value indicative of a degree to which the mutually exclusive set deviates from other members of the plurality of mutually exclusive sets with respect to the user-specified target feature; and
displaying the second deviation value associated with each of the plurality of mutually exclusive sets.

17. The method of claim 15, wherein the plurality of mutually exclusive sets are produced hierarchically on the sub-population.

18. The method of claim 15, wherein the similarity-based clustering produces a quasi-optimal number of mutually exclusive sets by an iterative process comprising:
creating a new set; and
successively adding clusters to the new set until the new set does not significantly differ from one or more prior sets.

19. The method of claim 15, wherein the computer system comprises a plurality of processors and the similarity-based clustering is performed in parallel.

20. The method of claim 14, wherein the computer system comprises a plurality of processors and each processor is configured to operate on a subset of the population in order to identify examples in the subset of the population meeting predetermined performance criteria.

21. The method of claim 14, wherein the computer system comprises a plurality of processors and each processor is configured to determine cohort deviation values over successive slices of the population in parallel.

22. The method of claim 14, further comprising:
identifying, by the computer system, a plurality of cohorts in the population related to the user-specified target feature;
identifying, by the computer system, additional feature-value pairs from the plurality of cohorts that deviate from the population mean value by more than the predetermined threshold value; and
displaying the additional feature-value pairs.

23. A system for profiling a population of examples, the system comprising:
a network interface configured to receive a user-specified target feature;
a plurality of processors configured to:
determine a performance measurement for each example in the population with regards to the user-specified target feature,
identify a sub-population of the examples based on the performance measurement determined for each example, wherein the sub-population comprises one of (i) highest performers with respect to the user-specified target feature or (ii) lowest performers with respect to the user-specified target feature,
determine a population mean value for the user-specified target feature across the population, and
identify feature-value pairs from the sub-population that deviate from the population mean value by more than a predetermined threshold value; and
a display configured to present the identified feature-value pairs.
